(19) United States
(12) Patent Application Publication
(10) Pub. No.: US 2022/0374493 A1
(43) Pub. Date: Nov. 24, 2022

(54) DATA PROCESSING METHOD AND CIRCUIT BASED ON CONVOLUTION COMPUTATION

(71) Applicant: Egis Technology Inc., Hsinchu City (TW)

(72) Inventors: Kun-Hua Huang, Hsinchu City (TW); Chih-Hsiung Lin, Hsinchu City (TW)

(73) Assignee: Egis Technology Inc., Hsinchu City (TW)

(21) Appl. No.: 17/718,323

(22) Filed: Apr. 12, 2022

Related U.S. Application Data
(60) Provisional application No. 63/190,252, filed on May 19, 2021.

(30) Foreign Application Priority Data
Mar. 4, 2022 (TW) 111107982

(51) Int. Cl. G06F 17/15

(52) U.S. Cl. CPC G06F 17/15

(57) ABSTRACT

A data processing method and circuit based on convolution computation are provided. In the data processing method, a shared memory structure is provided, convolution computation of data in batches or duplicated data is provided, an allocation mechanism for storing data into multiple memories is provided, and a signed padding mechanism is provided. Therefore, a flexible and efficient convolution computation mechanism and structure are provided.

### CROSS-REFERENCE TO RELATED APPLICATION

This application claims the priority benefit of U.S. Provisional Application No. 63/190,252, filed on May 19, 2021, and Taiwan Application No. 111107982, filed on Mar. 4, 2022. The entirety of each of the above-mentioned patent applications is hereby incorporated by reference herein and made a part of this specification.

### BACKGROUND

### Technical Field

The disclosure relates to a data processing mechanism, and more particularly to a data processing method and circuit based on convolution computation.

### Description of Related Art

The neural network is an important topic in artificial intelligence (AI), and makes decisions through simulating the operation of human brain cells. It is worth noting that there are many neurons in human brain cells, and the neurons are connected to one another through synapses. Each neuron receives a signal through a synapse, and the output of the signal after transformation is transmitted to another neuron. The transformation ability of each neuron is different, and through the operations of the signal transmission and transformation, human beings can form the abilities to think and judge. The neural network obtains the corresponding ability according to the aforementioned operating manner.

In the operation of the neural network, convolution computation is performed on an input vector and the weight of the corresponding synapse to extract features. It is worth noting that the number of input values and weight values may be large, but existing structures usually encounter issues such as higher power consumption, longer waiting time, and higher space usage for large amounts of data.

### SUMMARY

The disclosure provides a data processing method and circuit based on convolution computation, which can provide more efficient data configuration.

The data processing method based on convolution computation of the embodiment of the disclosure includes (but is not limited to) the following steps. Input data is extended according to a padding mode to generate extended input data. The input data is used for convolution computation. Coordinates of a two-dimensional coordinate system are provided to multiple elements in the extended input data. The elements in the extended input data are read according to location information. The location information includes a size of non-extended input data and coordinates of the elements in the extended input data. In response to a coordinate of an element in the location information being located outside the non-extended input data in the two-dimensional coordinate system, the coordinate in the location information is converted according to the padding mode. The coordinate in the location information is mapped to a coordinate of the non-extended input data.

The data processing circuit based on convolution computation of the embodiment of the disclosure includes (but is not limited to) one or more memories and processors. The memory is used to store a code. The processor is coupled to the memory. The processor is configured to load and execute the code to execute the following steps. Input data is extended according to a padding mode to generate extended input data. The input data is used for convolution computation. Coordinates of a two-dimensional coordinate system are provided to multiple elements in the extended input data. The elements in the extended input data are read according to location information. The location information includes a size of non-extended input data and coordinates of the elements in the extended input data. In response to a coordinate of an element in the location information being located outside the non-extended input data in the two-dimensional coordinate system, the coordinate in the location information is converted according to the padding mode. The coordinate in the location information is mapped to a coordinate of the non-extended input data.

Based on the above, in the data processing method and circuit based on convolution computation according to the embodiments of the disclosure, multiple groups of convolution kernel groups may be formed and processed in batches, thereby effectively utilizing the memory space and improving the computation efficiency.

In order for the features and advantages of the disclosure to be more comprehensible, the following specific embodiments are described in detail in conjunction with the drawings.

### BRIEF DESCRIPTION OF THE DRAWINGS

FIG. 1 is a block diagram of elements of a data processing circuit according to an embodiment of the disclosure.

FIG. 2 is a flowchart of a data processing method-storage configuration according to an embodiment of the disclosure.

FIG. 3 is a schematic diagram of input data according to an embodiment of the disclosure.

FIG. 4 is a schematic diagram of storage spaces of multiple memories according to an embodiment of the disclosure.

FIG. 5A is a schematic diagram of storage configurations of multiple memories according to an embodiment of the disclosure.

FIG. 5B is a schematic diagram of storage configurations of multiple memories according to an embodiment of the disclosure.

FIG. 5C is a schematic diagram of storage configurations of multiple memories according to an embodiment of the disclosure.

FIG. 6 is a flowchart of a data processing method-padding extension according to an embodiment of the disclosure.

FIG. 7A is a schematic diagram of input data according to an embodiment of the disclosure.

FIG. 7B is a schematic diagram of padded input data according to an embodiment of the disclosure.

FIG. 8 is a schematic diagram of a shared memory according to an embodiment of the disclosure.

FIG. 9 is a flowchart of a data processing method-computation configuration according to an embodiment of the disclosure.

FIG. 10 is a schematic diagram of convolution computation according to an embodiment of the disclosure.

FIG. 11 is a schematic diagram of convolution computation according to an embodiment of the disclosure.

FIG. 12 is a schematic diagram of convolution computation according to an embodiment of the disclosure.

FIG. 13 is a schematic diagram of parallel computation according to an embodiment of the disclosure.

FIG. 14 is a schematic diagram of data duplication according to an embodiment of the disclosure.

FIG. 15 is a schematic diagram of data duplication according to an embodiment of the disclosure.

FIG. 16 is a flowchart of overall data processing according to an embodiment of the disclosure.

### DETAILED DESCRIPTION OF DISCLOSED EMBODIMENTS

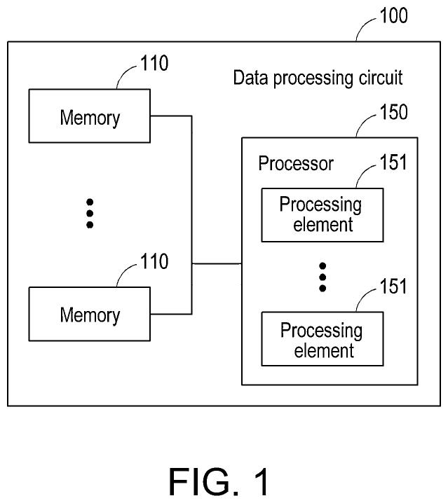

FIG. 1 is a block diagram of elements of a data processing circuit 100 according to an embodiment of the disclosure. Please refer to FIG. 1. The data processing circuit 100 includes (but is not limited to) one or more memories 110 and processors 150.

The memory 110 may be a static or dynamic random access memory (RAM), a read-only memory (ROM), a flash memory, a register, a combinational logic circuit, or a combination of the above elements. In an embodiment, the memory 110 is used to store input data, a convolution kernel, a weight, activation computation, pooling computation used by multiply accumulate (MAC) or convolution computation, and/or values used by other neural network computations. In other embodiments, a user may determine the type of data stored in the memory 110 according to actual requirements. In an embodiment, the memory 110 is used to store a code, a software module, a configuration, data, or a file, which will be described in detail in subsequent embodiments.

The processor 150 is coupled to the memory 110. The processor 150 may be a circuit composed of one or more of a multiplexer, an adder, a multiplier, an encoder, a decoder, or various logic gates, and may be a central processing unit (CPU), a graphic processing unit (GPU), other programmable general-purpose or specific-purpose microprocessors, digital signal processors (DSPs), programmable controllers, field programmable gate arrays (FPGAs), application-specific integrated circuits (ASICs), neural network accelerator, other similar elements, or a combination of the above elements. In an embodiment, the processor 150 is configured to execute all or part of the operations of the data processing circuit 100, and may load and execute various software modules, codes, files, and data stored in the memory 110. In some embodiments, the operation of the processor 150 may be implemented through software.

In an embodiment, the processor 150 includes one or more processing elements (PE) 151. The processing elements 151 are configured to execute operations specified by the same or different commands. For example, convolution computation, matrix computation, or other computations.

Hereinafter, the method described in the embodiment of the disclosure will be described with reference to various elements or circuits in the data processing circuit 100. Each process of the method may be adjusted according to the implementation situation and is not limited thereto.

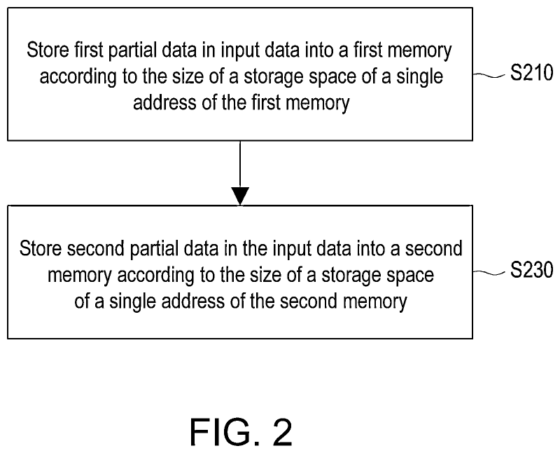

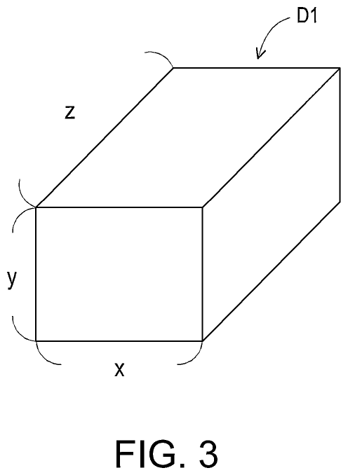

FIG. 2 is a flowchart of a data processing method-storage configuration according to an embodiment of the disclosure. Please refer to FIG. 2. The processor 150 stores first partial data in the input data into the memory 110 according to the size of a storage space of a single address of a first memory among multiple memories 110 (a certain address of the memory 110 is hereinafter referred to as a first address) (Step S210). Specifically, the size of the input data to be processed each time is not necessarily the same. For example, FIG. 3 is a schematic diagram of input data D1 according to an embodiment of the disclosure. Please refer to FIG. 3. The size/dimensions of the input data D1 is a width x*a height y*a channel number z. That is, the input data D1 includes x*y*z elements. Taking a coordinate system as an example, coordinates of the elements whose channel number z is zero in the input data D1 may be labelled as:

TABLE 1

| | | | | | | | |
|---|---|---|---|---|---|---|---|
| x0, y0 | x1, y0 | x2, y0 | x3, y0 | x4, y0 | x5, y0 | x6, y0 | x7, y0 |
| x0, y1 | x1, y1 | x2, y1 | x3, y1 | x4, y1 | x5, y1 | x6, y1 | x7, y1 |
| x0, y2 | x1, y2 | x2, y2 | x3, y2 | x4, y2 | x5, y2 | x6, y2 | x7, y2 |
| x0, y3 | x1, y3 | x2, y3 | x3, y3 | x4, y3 | x5, y3 | x6, y3 | x7, y3 |
| x0, y4 | x1, y4 | x2, y4 | x3, y4 | x4, y4 | x5, y4 | x6, y4 | x7, y4 |
| x0, y5 | x1, y5 | x2, y5 | x3, y5 | x4, y5 | x5, y5 | x6, y5 | x7, y5 |
| x0, y6 | x1, y6 | x2, y6 | x3, y6 | x4, y6 | x5, y6 | x5, y6 | x5, y6 |

It should be noted that the values of the width x and the height y shown in Table (1) are only for illustration, and the channel number z may be 8, 16, 32, or other values. In addition, the input data may be a sensing value, an image, detection data, a feature map, a convolution kernel, or a weight used in subsequent convolution computation or other computations, and the content thereof may be changed according to actual requirements of the user.

It is worth noting that a location where data is stored in the memory 110 may affect the efficiency and the space usage rate of subsequent data access. In the embodiment of the disclosure, the size of the first partial data is not greater than the size of the storage space of the first address. In other words, the processor 150 divides the input data into multiple partial data according to the size of the storage space provided by the single address, and stores the partial data in the input data into the memory 110. Here, the partial data represents part or all of the input data.

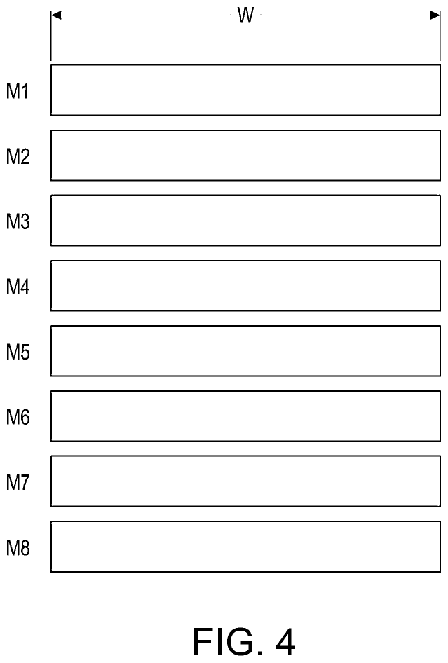

In an embodiment, the processor 150 compares the channel number of the input data with the size of the storage space of the first address. Each memory 110 includes one or more memory addresses (for example, the first address), and each memory address provides a certain size of the storage space for data storage. For example, FIG. 4 is a schematic diagram of storage spaces of multiple memories according to an embodiment of the disclosure. Please refer to FIG. 4. It is assumed that the data processing circuit 100 includes memories M1 to M8, and a width W (that is, the storage space) of a single address of each of the memories M1 to M8 is 32 bytes.

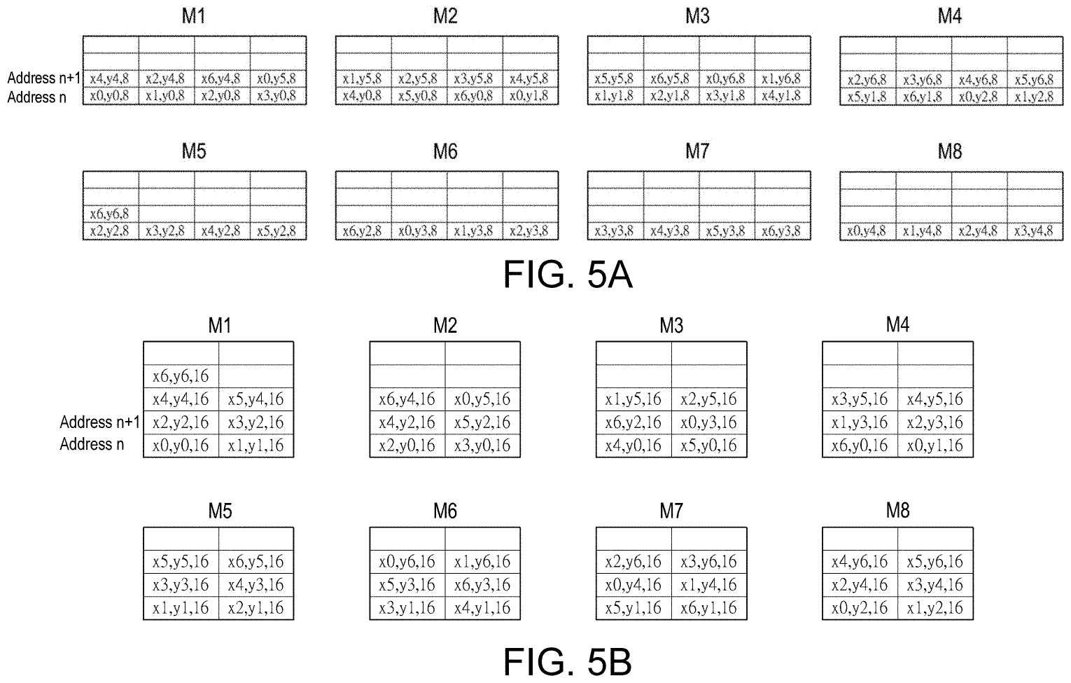

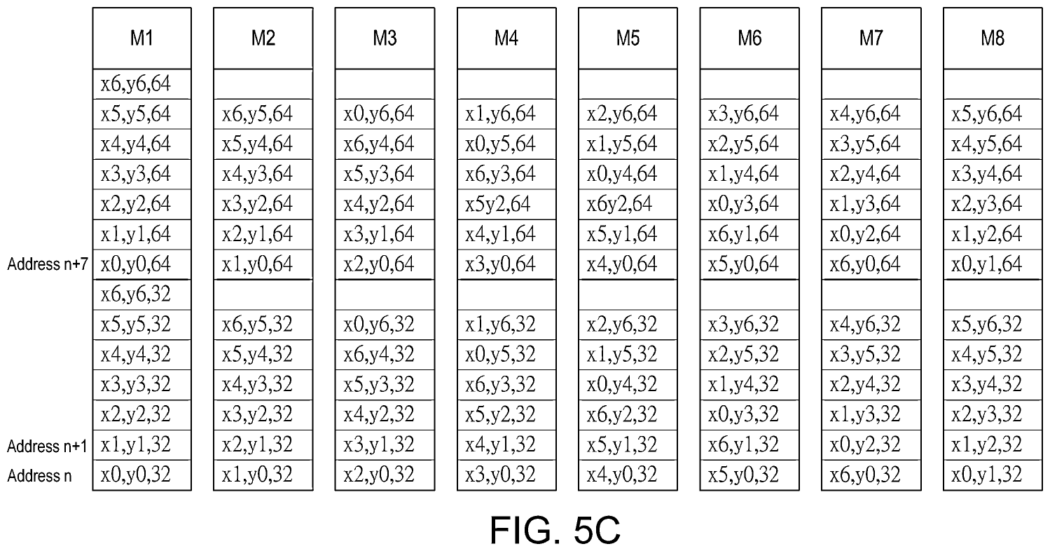

FIG. 5A is a schematic diagram of storage configurations of multiple memories according to an embodiment of the disclosure. Please refer to FIG. 4 and FIG. 5A. Assuming that the size of the input data is 7×7×8, the processor 150 compares the channel number (that is, 8) and the width (that is, 32) of the first address, and obtains a comparison result of the width being four times the channel number.

FIG. 5B is a schematic diagram of storage configurations of multiple memories according to an embodiment of the disclosure. Please refer to FIG. 4 and FIG. 5B. Assuming that the size of the input data is 7×7×16, the processor 150 compares the channel number (that is, 16) and the width (that is, 32) of the first address, and obtains a comparison result of the width being twice the channel number.

FIG. 5C is a schematic diagram of storage configurations of multiple memories according to an embodiment of the disclosure. Please refer to FIG. 4 and FIG. 5C. Assuming that the size of the input data is 7×7×64, the processor 150 compares the channel number (that is, 64) and the width (that is, 32) of the first address, and obtains a comparison result of the channel number being twice the width.

The processor 150 may determine an element number of the elements of the input data included in the first partial data according to the comparison result between the channel number and the size of the storage space of the first address. In an embodiment, if the processor 150 determines that the comparison result is that the channel number is not greater than the size of the storage space of the first address, the processor 150 further determines that the product of the channel number and the element number is not greater than the size of the storage space of the first address.

Taking FIG. 5A as an example, the width of a single address is four times the channel number. Therefore, the element number may be 4, 3, 2, or 1. Taking 4 elements as an example, an address n (positive integer) of the memory M1 stores elements of channels 1 to 8 and whose coordinates are (x0, y0) (taking the coordinate system of Table (1) as an example), (x1, y0), (x2,y0), and (x3,y0) in the input data. Taking FIG. 5B as an example, the width is twice the channel number. Therefore, the element number may be 2 or 1. Taking 2 elements as an example, the address n stores elements of channels 1 to 8 and whose coordinates are (x1, y0) and (x1, y0) in the input data. It can be seen that the first address stores elements of multiple channels with the same coordinates in the input data, and in the embodiment of the disclosure, all channels of a single element are preferentially allocated.

In another embodiment, if the processor 150 determines that the comparison result is that the channel number is greater than the size of the storage space of the first address, the processor 150 further determines that the element number included in the first partial data is one. Since the size of the storage space of a single address is not enough to store all channels of a single element, the processor 150 may split the channels.

Taking FIG. 5C as an example, the channel number of a single address is twice the width. Therefore, the element number is 1, and the processor 150 splits the 64 channels into channels 1 to 32 and channels 33 to 64. The address n stores elements of channels 1 to 32 and whose coordinates are (x0, y0) in the input data.

Please refer to FIG. 2. The processor 150 stores second partial data in the input data into a second memory according to the size of a storage space of a single address of the second memory among the memories 110 (a certain address of the memory 110 is hereinafter referred to as the second address) (Step S230). Specifically, the size of the second partial data is not greater than the size of the storage space of the second address. It is worth noting that the coordinates of the first partial data stored at the first address in two-dimensional coordinates of the input data of any channel are different from the coordinates of the second partial data stored at the second address. That is, the processor 150 continues to process other data in the input data that has not been stored. Similarly, in an embodiment, the processor 150 compares the channel number of the input data with the size of the storage space of the second address, and determines the element number of the elements of the input data included in the second partial data according to a comparison result between the channel number and the size of the storage space of the second address.

In an embodiment, if the processor 150 determines that the comparison result is that the channel number is not greater than the size of the storage space of the second address, the processor 150 further determines that the product of the channel number and the element number is not greater than the size of the storage space of the second address. Taking FIG. 5A and 4 elements as an example, the address n of the memory M2 stores elements of channels 1 to 8 and whose coordinates are (x4, y0), (x5, y0), (x6, y0), and (x7, y0) in the input data (since the coordinates (x0, y0), (x1, y0), (x2, y0), and (x3, y0) have been stored in the memory M1, the coordinates are allocated in sequence). Taking FIG. 5B and 2 elements as an example, the address n of the memory M2 stores elements of channels 1 to 8 and whose coordinates are (x2, y0) and (x3, y0) in the input data.

In another embodiment, if the processor 150 determines that the comparison result is that the channel number is greater than the size of the storage space of the second address, the processor 150 further determines that the element number included in the second partial data is one. Taking FIG. 5C as an example and the element number is 1, the address n of the memory M2 stores elements of channels 1 to 32 and whose coordinates are (x1, y0) in the input data. In addition, by analogy, the processor 150 may allocate other partial data to other memories M3 to M8.

In an embodiment, the processor 150 may store third partial data in the input data into a third address (different from the first address) of the first memory according to the size of the storage space of the third address of the first memory. The size of the third partial data is not greater than the size of the storage space of the third address. In addition, coordinates of the third partial data stored at the third address in the two-dimensional coordinates of the input data of any channel may be the same as or different from the coordinates of the first partial data stored at the first address.

Taking FIG. 5C as an example, the address n of the memory M1 stores elements whose coordinates are (x0, y0), an address n+1 of the memory M1 stores elements whose coordinates are (x1, y1), and an address n+7 of the memory M1 stores elements whose coordinates are (x0, y0). In some embodiments, channels included in the third partial data may be different from the channels included in the first partial data. Taking FIG. 5C as an example, the address n of the memory M1 stores elements whose coordinates are (x1, y1) and of channels 1 to 32, and the address n+7 stores elements whose coordinates are (x1, y1) and of channels 33 to 64.

In this way, the embodiment of the disclosure can fully utilize the storage space in the memory 110.

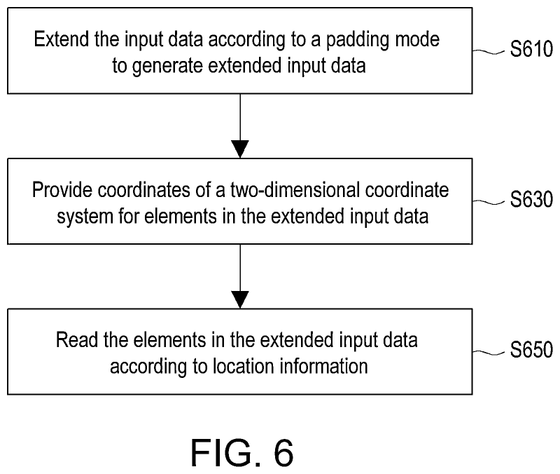

FIG. 6 is a flowchart of a data processing method-padding extension according to an embodiment of the disclosure. Please refer to FIG. 6. The processor 150 extends the input data according to a padding mode to generate extended input data (Step S610). Specifically, in some application scenarios (for example, convolution computation of data or the requirement of maintaining boundary information), the size of the input data needs to be extended, and the requirement may be achieved through padding data. The padding mode may be a reflect mirror mode or a symmetric mirror mode.

For example, the input data is shown in Table (2):

TABLE 2

| | | |
|---|---|---|
| 1 | 2 | 3 |
| 4 | 5 | 6 |

If padded with the reflect mirror mode, the following may be obtained:

TABLE 3

| | | | | | | |
|---|---|---|---|---|---|---|
| 2 | 1 | 1 | 2 | 3 | 3 | 2 |
| 2 | 1 | 1 | 2 | 3 | 3 | 2 |
| 5 | 4 | 4 | 5 | 6 | 6 | 5 |
| 5 | 4 | 4 | 2 | 6 | 6 | 5 |

If padded with the symmetric mirror mode, the following may be obtained:

TABLE 4

| | | | | | | |
|---|---|---|---|---|---|---|
| 6 | 5 | 4 | 5 | 6 | 5 | 4 |
| 3 | 2 | 1 | 2 | 3 | 2 | 1 |
| 6 | 5 | 4 | 5 | 6 | 5 | 4 |
| 3 | 2 | 1 | 2 | 3 | 2 | 1 |

The processor 150 provides coordinates of a two-dimensional coordinate system for multiple elements in the extended input data (Step S630). Specifically, in terms of the width and the height of the input data under a single channel, the elements may form a matrix. If a coordinate is provided for each element of the matrix, the two-dimensional coordinate system may be adopted. The horizontal axis of the two-dimensional coordinate system corresponds to the width of the input data, and the vertical axis of the coordinate system corresponds to the height of the input data. Furthermore, any integer value on the axis corresponds to one or more elements of the input data.

In an embodiment, the processor 150 may set coordinates of non-extended input data to be between 0 and w in a first dimension (that is, the horizontal axis) and between 0 and h in a second dimension (that is, the vertical axis), where w is the width of the non-extended input data, and h is the height of the non-extended input data. In addition, the processor 150 may set the coordinates in the extended input data that do not belong to the non-extended input data to be less than zero or greater than w in the first dimension and less than zero or greater than h in the second dimension.

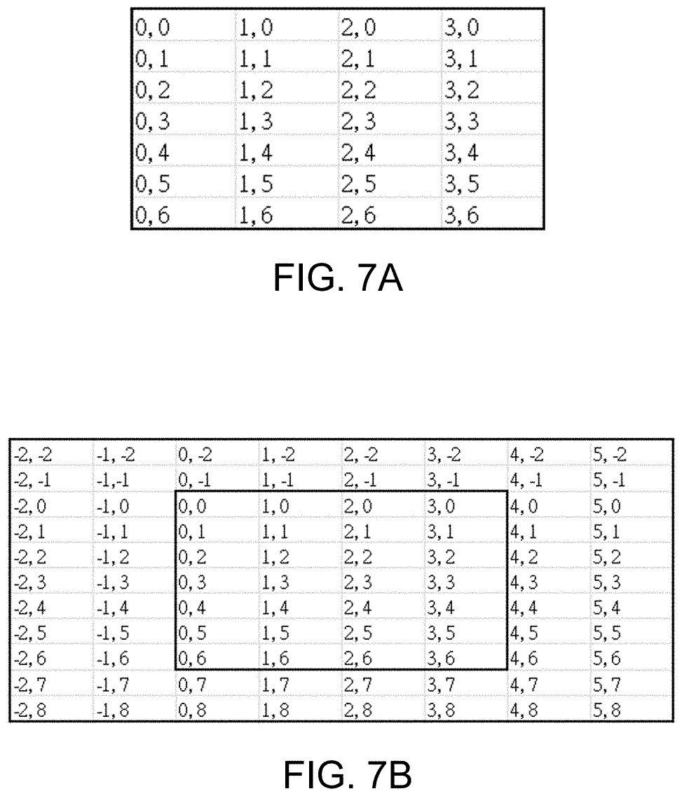

For example, FIG. 7A is a schematic diagram of input data according to an embodiment of the disclosure. Please refer to FIG. 7A. In the coordinates (x, y) of the input data with a width of 3 and a height of 6, x is 0 to 3 and y is 0 to 6. FIG. 7B is a schematic diagram of padded input data (that is, extended input data) according to an embodiment of the disclosure. Please refer to FIG. 7B. Assuming that the processor 150 pads each of the top, bottom, left, and right of the input data outward by two elements, in the coordinates (x, y) of the extended input data, x is −2 to 5 and y is −2 to 8. It can be seen that for the coordinates of padded elements, the x or y coordinate is less than zero, the x coordinate is greater than w, or the y coordinate is greater than h. It is worth noting that negative values need to be represented by signed numbers, but signed numbers are not good for storing or calling.

Please refer to FIG. 6. The processor 150 reads the elements in the extended input data according to location information (Step S650). Specifically, the location information includes the size of the non-extended input data and the coordinates of the elements in the extended input data. For example, the location information is (w, h, c, x, y), where w is the width of the input data, h is the height of the input data, c is the channel of the input data, x is the coordinate of the horizontal axis of a certain element in the two-dimensional coordinate system, and y is the coordinate of the vertical axis of the element in the two-dimensional coordinate system. The input data is stored in the memory 110. If a specific element in the input data is to be read, the processor 150 may access the element according to the location information.

Unlike the coordinates using signed numbers, if a coordinate of a certain element in the location information is located outside the non-extended input data in the two-dimensional coordinate system, the processor 150 converts the coordinates in the location information according to the padding mode. It is worth noting that the coordinates in the location information are all mapped to the coordinates of the non-extended input data. In other words, the coordinates representing the locations of the elements in the location information may all correspond to positive values.

Taking Table (3) and Table (4) as an example, the values of the padded elements are all the same as the value of a certain element in the non-extended input data. Therefore, the coordinates of the padded elements may be replaced by the coordinates of the elements with the same value in the non-extended input data.

In an embodiment, assuming that the width of the non-extended input data is w and the height is h, the processor 150 may determine whether the coordinate of a certain element corresponding to the location information is less than zero or greater than w in the first dimension and/or determine whether the coordinate of the element corresponding to the location information is less than zero or greater than h in the second dimension. If the coordinate is less than zero or greater than w in the first dimension or less than zero or greater than h in the second dimension, the processor 150 judges that the element belongs to the extended input data. On the contrary, if the coordinate is not less than zero or not greater than w in the first dimension or not less than zero or not greater than h in the second dimension, the processor 150 judges that the element belongs to the non-extended input data.

For coordinate conversion, in an embodiment, the padding mode is the reflect mirror mode. If the processor 150 determines that the coordinate of a certain element corresponding to the location information is less than zero in the first dimension, the processor 150 further converts a first coordinate of the element in the first dimension into the absolute value of the first coordinate, which is mathematically expressed as:

If x<0, then ABS(x) (1)

where ABS( ) represents the absolute value.

If the processor 150 determines that the coordinate of the element corresponding to the location information is greater than w in the first dimension, the processor 150 further converts the first coordinate of the element into the difference between the first coordinate and twice w (or w minus the value obtained by taking the absolute value of the difference between w and the first coordinate), which is mathematically expressed as:

If x>w, then (w−ABS(w−x)) (2)

If the processor 150 determines that the coordinate of the element corresponding to the location information is less than zero in the second dimension, the processor 150 further converts the second coordinate of the element in the second dimension into the absolute value of the second coordinate, which may be mathematically expressed as:

If y<0, then ABS(y) (3)

If the processor 150 determines that the coordinate of the element corresponding to the location information is greater than h in the second dimension, the processor 150 further converts the second coordinate of the element into the difference between the second coordinate and twice h (or h minus the value obtained by taking the absolute value of the difference between h and the second coordinate), which is mathematically expressed as:

If y>h, then (h−ABS(h−y)) (4)

In another embodiment, the padding mode is the symmetric mirror mode. If the processor 150 determines that the coordinate of a certain element corresponding to the location information is less than zero in the first dimension, the processor 150 further converts the first coordinate of the element in the first dimension into the absolute value of the first coordinate plus one, which is mathematically expressed as:

If x<0, then ABS(x+1) (5)

If the processor 150 determines that the coordinate of the element corresponding to the location information is greater than w in the first dimension, the processor 150 further converts the first coordinate of the element into the difference between the first coordinate plus one and twice w (or w minus the value obtained by taking the absolute value of the difference between the first coordinate, w, and 1), which is mathematically expressed as:

If x>w, then(w−ABS(x−w−1)) (6)

If the processor 150 determines that the coordinate of the element corresponding to the location information is less than zero in the second dimension, the processor 150 further converts the second coordinate of the element in the second dimension into the absolute value of the second coordinate plus one, which is mathematically expressed as:

If y<0, then ABS(y+1) (7)

If the processor 150 determines that the coordinate of the element corresponding to the location information is greater than h in the second dimension, the processor 150 further converts the second coordinate of the element into the difference between the second coordinate plus one and twice h (or h minus the value obtained by taking the absolute value of the difference between the second coordinate, h, and 1), which is mathematically expressed as:

If y>h, then(h−ABS(y−h−1)) (8)

It can be seen that the processor 150 may determine that the value of the element indicated by the location information is one of the non-extended input data according to the padding mode. Therefore, as long as the size of the non-extended input data and the type of the padding mode are given, the element of the extended input data may be accessed.

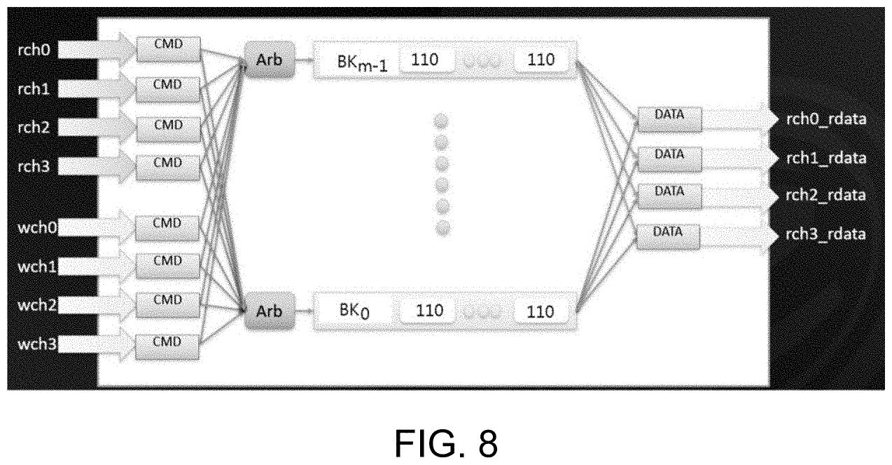

In an embodiment, in order to efficiently access the data stored in the memory 110, the embodiment of the disclosure further provides a shared memory structure. FIG. 8 is a schematic diagram of a shared memory according to an embodiment of the disclosure. Please refer to FIG. 8. The processor 150 may combine one or more memories 110 into one memory bank (for example, memory banks Bk₀ to Bkₘ₋₁, where m is a positive integer). Each of the memory banks Bk₀ to Bkₘ₋₁ is provided with an arbiter Arb.

In an embodiment, the arbiter Arb is used to judge a storage location indicated by a command CMD. Taking FIG. 8 as an example, it is assumed that the 8 commands CMD shown in the drawing are respectively used to read one or more elements (for example, data to be read rch0 to rch3) of data (for example, the input data or convolution kernel/weight) and write one or more elements (for example, data to be written wch0 to wch3) of data. In an embodiment, the command CMD may include the location information indicating the coordinates of the element. For example, the coordinates of the two-dimensional coordinate system shown in Table (1) or the three-dimensional coordinate system combined with the channel. In an embodiment, the command CMD may further include the size of the input data. For example, the width, the height, and/or the channel of the input data. In an embodiment, the command CMD may further include the padding mode.

In an embodiment, each arbiter Arb judges whether the indicated element is in the memory banks Bk₀ to Bkₘ₋₁ to which the element belongs according to the location information of the command CMD. If the indicated element is in the memory banks Bk₀ to Bkₘ₋₁ to which the element belongs, the arbiter Arb sends a read or write command to the memory bank Bk₀, Bk₁, . . . , or Bkₘ₋₁ to which the element belongs to read or write the element. If the indicated element is not in the memory banks Bk₀ to Bkₘ₋₁ to which the element belongs, the arbiter Arb ignores the command CMD or disables/does not issue the read/write command of the element.

Taking FIG. 8 as an example, the arbiter Arb judges to read the command CMD of one or more elements rch0 to rch3 of the input data, and may read data DATA (for example, read data rch0_rdata to rch3_rdata) of the elements rch0 to rch3.

In an embodiment, each arbiter Arb sorts the commands CMD according to the location information of the commands CMD. Two or more commands CMD received by the arbiter Arb may all access the same element, and the arbiter Arb may sort the commands CMD.

In an embodiment, the command CMD and the data DATA are input or output according to a first input first output (FIFO) mechanism. A first input first output register may firstly remove the first command CMD or data DATA that enters, and secondly remove the second command CMD or data DATA that enters, and the remaining sequence may be analogized. Therefore, the efficiency of data access can be improved.

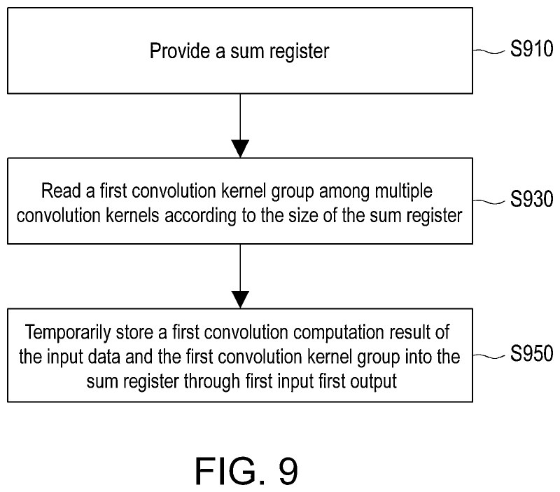

FIG. 9 is a flowchart of a data processing method-computation configuration according to an embodiment of the disclosure. Please refer to FIG. 9. The processor 150 provides a sum register (Step S910). In particular, the processor 150 or the processing element 151 may be configured with a computation amount with a specific size. For example, the single computation amount is 3×3×32. It should be noted that the computation amount may vary due to specifications or application requirements and is not limited in the embodiment of the disclosure. In addition, the sum register is used to store data output by the processor 150 or the processing element 151 after computation. However, the size of the sum register may be changed according to the requirements of the user and is not limited in the embodiment of the disclosure.

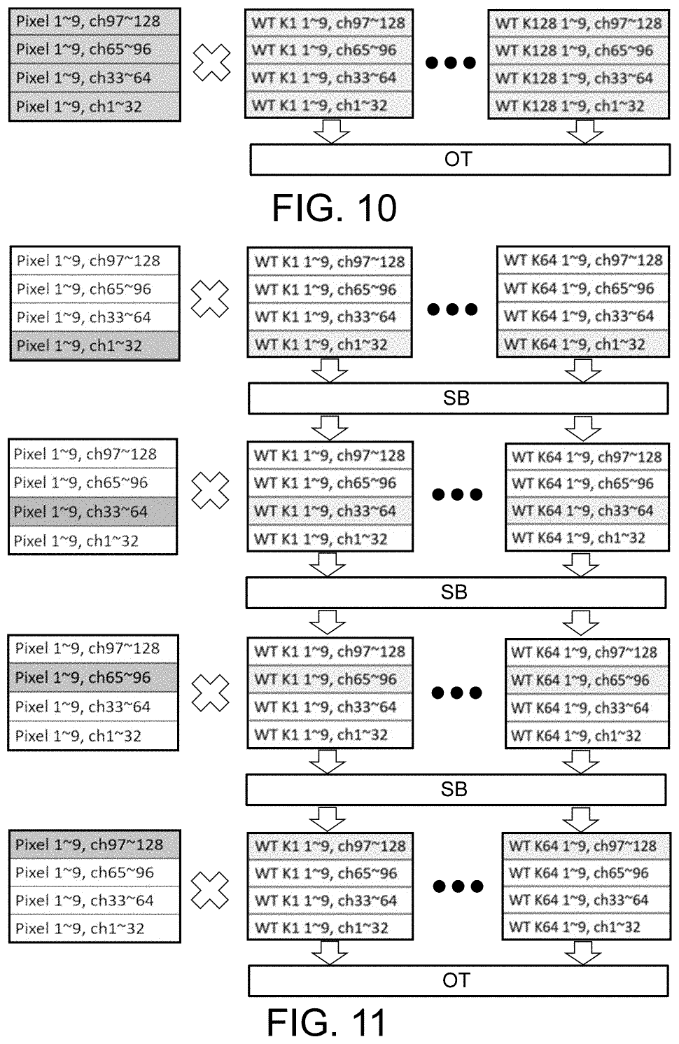

It is worth noting that the amount of data that needs to be computed may exceed the computation amount. For example, FIG. 10 is a schematic diagram of convolution computation according to an embodiment of the disclosure. Please refer to FIG. 10, the size of input data Pixel is 3×3×128, the size of a convolution kernel WT is 3×3×128, and there is a total of 128 convolution kernels K1 to K128. 1˜9 shown in the drawing represent the 1-st to 9-th elements of a channel in the input data Pixel or the 1-st to 9-th elements of a channel in the convolution kernel WT. In addition, ch1˜32 (that is, ch1 to ch32) shown in the drawing represent the 1-st to 32-nd channels, ch33˜64 (that is, ch33 to ch64) represent the 33-rd to 64-th channels, and the rest may be analogized. Assuming that 3×3×32 convolution computation (for example, an output register OT only provides an output amount of 3×3×32) is performed, convolution computation of all 3×3×128 input data Pixel and 128 convolution kernels K1 to K128 cannot be completed at one time. Therefore, the computation of a large amount of data can be implemented through batch computation.

The processor 150 reads a first convolution kernel group among multiple convolution kernels according to the size of the sum register (Step S930). Specifically, the number of the convolution kernels in the first convolution kernel group is the same as the size of the sum register. Taking FIG. 10 as an example, if convolution computation is 3×3×32 and the size of the sum register is 64, the first convolution kernel group may include the channels ch1 to ch32 of the convolution kernels K1 to K64.

The processor 150 temporarily stores a first convolution computation result of the input data and the first convolution kernel group into the sum register through first input first output (FIFO) (Step S950). Specifically, the processor 150 may execute 3×3 convolution computation of the i-th channel (where i is a positive integer) and store the computation result into the sum register, then execute 3×3 convolution computation of the (i+1)-th channel and store the computation result into the sum register, and the rest may be analogized.

For example, FIG. 11 is a schematic diagram of convolution computation according to an embodiment of the disclosure. Please refer to FIG. 11. The first convolution kernel group is the channels ch1 to ch32 of the convolution kernels K1 to K64. The processor 150 respectively executes 3×3 convolution computation on the input data Pixel of a 1-st channel and the convolution kernels K1 to K64, and respectively outputs the computation results to a sum register SB. Next, the processor 150 respectively executes 3×3 convolution computation on the input data Pixel of a 2-nd channel and the convolution kernels K1 to K64, and respectively outputs the computation results to the sum register SB. Computation of other channels may be analogized and will not be repeated.

In an embodiment, the input data includes fourth partial data and fifth partial data, and the fourth partial data and the fifth partial data belong to different channels. The first convolution kernel group includes a first partial kernel and a second partial kernel, and the first partial kernel and the second partial kernel belong to different channels. In addition, the first convolution computation result is only based on the first partial data and the first partial kernel.

Taking FIG. 11 as an example, the fourth partial data is the channels ch1 to ch32 of the input data Pixel, and the fifth partial data is the channels ch33 to ch64 of the input data Pixel. The first partial kernel is the channels ch1 to ch32 of the convolution kernels K1 to K64, and the second partial kernel is the channels ch33 to ch64 of the convolution kernels K1 to K64. The first convolution computation result is the computation result of the channels ch1 to ch32 of the input data Pixel and the channels ch1 to ch32 of the convolution kernels K1 to K64.

Next, the processor 150 reads the second partial kernel in the first convolution kernel group according to the size of the sum register. Taking FIG. 11 as an example, the processor 150 reads the channels ch33 to ch64 of the convolution kernels K1 to K64 from the memory 110.

In addition, the processor 150 reads the first convolution computation result from the sum register. Taking FIG. 11 as an example, the processor 150 reads the computation result of the channels ch1 to ch32 of the input data Pixel and the channels ch1 to ch32 of the convolution kernels K1 to K64 from the sum register SB.

The processor 150 temporarily stores the sum of a second convolution computation result of the second partial data and the second partial kernel and the first convolution computation result from the sum register into the sum register through first input first output. Taking FIG. 11 as an example, the processor 150 adds the computation result of the channels ch1 to ch32 of the input data Pixel and the channels ch1 to ch32 of the convolution kernels K1 to K64 and the computation result of the channels ch33 to ch64 of the input data Pixel and the channels ch33 to ch64 of the convolution kernels K1 to K64, and stores the sum into the sum register SB according to the channel sequence and first input first output.

Next, the processor 150 executes convolution computation of the channels ch65 to ch96 of the input data Pixel and the channels ch65 to ch96 of the convolution kernels K1 to K64 and stores the computation result into the sum register, and the rest may be analogized until all of the channels ch1 to ch128 of the input data Pixel have been computed.

On the other hand, the processor 150 reads a second convolution kernel group among the convolution kernels according to the size of the sum register. Since the size of the sum register is less than the number of all convolution kernels, it is necessary to compute multiple convolution kernel groups in batches. Similarly, the number of the convolution kernels in the second convolution kernel group is the same as the size of the sum register, and the convolution kernels in the second convolution kernel group are different from the convolution kernels in the first convolution kernel group.

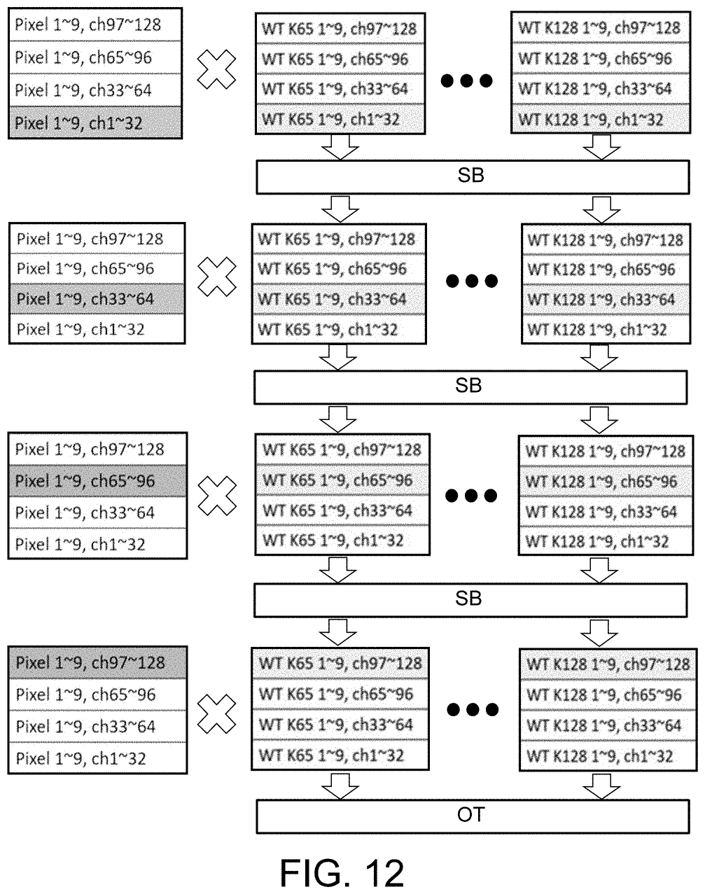

For example, FIG. 12 is a schematic diagram of convolution computation according to an embodiment of the disclosure. Please refer to FIG. 11 and FIG. 12. The difference from the convolution kernels K1 to K64 in FIG. 11 is that the second convolution kernel group includes the convolution kernels K65 to K128.

The processor 150 temporarily stores a third convolution computation result of the input data and the second convolution kernel group into the sum register through first input first output. Taking FIG. 12 as an example, the processor 150 first performs convolution computation on the channels ch1 to ch32 of the convolution kernels K65 to K128 and stores the computation result into the sum register. Next, the processor 150 performs convolution computation on the channels ch33 to ch64 of the convolution kernels K65 to K128. The remaining computation may be analogized and will not be repeated.

It should be noted that batch computation in the embodiment of the disclosure can provide a more flexible computation structure. In an embodiment, parallel computation may be provided. Taking FIG. 11 and FIG. 12 as an example, the embodiments shown in the two drawings are both directed to the same input data Pixel. At this time, the processor 150 may provide another one or more sum registers. Similarly, the processor 150 may read the first convolution kernel group according to the size of another one or more sum registers, and temporarily store the input data and a fourth convolution computation result of the first convolution kernel group into another one or more sum registers through first input first output. For the same input data, the processor 150 may copy the input data or output the same input data for use in different convolution computations.

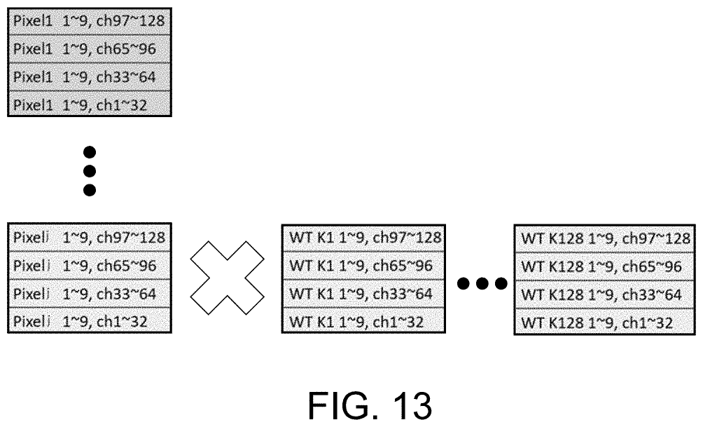

For example, FIG. 13 is a schematic diagram of parallel computation according to an embodiment of the disclosure. Please refer to FIG. 13. Multiple identical input data Pixel1 to Pixelj (where j is a positive integer) may be respectively and parallelly computed with the same convolution kernels K1 to K128. The input data Pixel1 is computed with the channels ch1 to ch32 of the convolution kernels K1 to K64, the input data Pixelj is computed with the channels ch1 to ch32 of the convolution kernels K1 to K64, and the rest may be analogized.

In an embodiment, the processor 150 provides two or more processing elements 151. The processor 150 may provide the read first convolution kernel group to the processing elements 151. In other words, a certain convolution computation result is determined through a certain processing element 151, and another convolution computation result is determined through another processing element 151. Taking FIG. 13 as an example, assuming that j is 2, a certain processing element 151 performs convolution computation on the input data Pixel1 and the channels ch1 to ch32 of the convolution kernels K1 to K64, and another processing element 151 performs convolution computation on the input data Pixelj and the channels ch1 to ch32 of the convolution kernels K1 to K64 (at the same time).

In this way, multiple input data may be parallelly computed with the same convolution kernels, there is (partial first input first output depth) time to load the input data, each input data may be allocated to one processing element 151, and more processing elements 151 may be easily extended to according to requirements.

It is worth noting that the disclosure can further provide different computation allocation mechanisms according to the size of the convolution kernel. FIG. 9 shows an embodiment of batch computation. In an embodiment, the processor 150 may judge whether the size of a certain one or more convolution kernels is less than the computation amount of convolution computation. Taking FIG. 11 as an example, convolution computation has a computation amount of 3×3×32. The size of each of the convolution kernels K1 to K128 is 3×3×128. Therefore, the size of each of the convolution kernels K1 to K128 is not less than the computation amount of convolution computation.

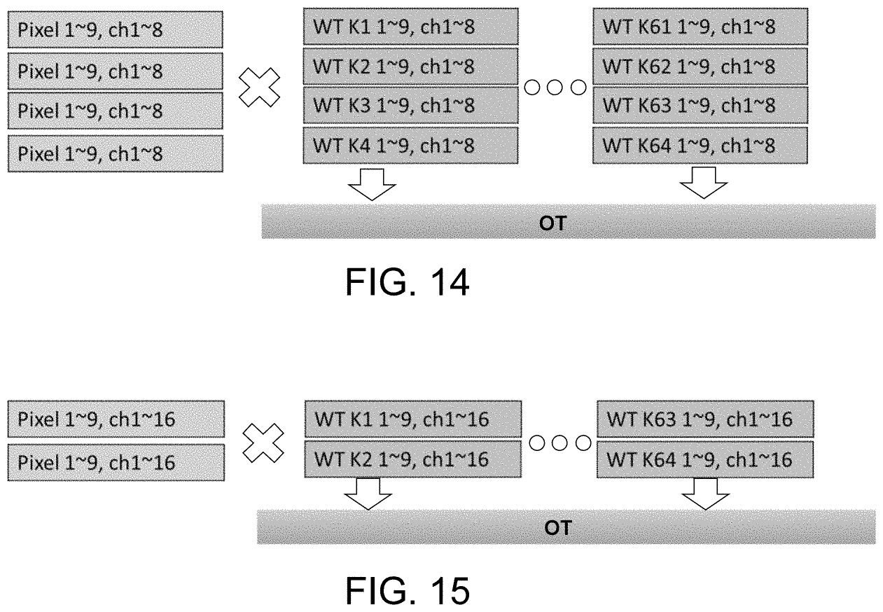

For another example, FIG. 14 is a schematic diagram of data duplication according to an embodiment of the disclosure. Please refer to FIG. 14. Convolution computation still has a computation amount of 3×3×32, and the size of the input data Pixel is 3×3×8. The size of each of the convolution kernels K1 to K64 is 3×3×8. Therefore, the size of each of the convolution kernels K1 to K64 is less than the computation amount of convolution computation. For another example, FIG. 15 is a schematic diagram of data duplication according to an embodiment of the disclosure. Please refer to FIG. 15. Convolution computation still has a computation amount of 3×3×32, and the size of the input data Pixel is 3×3×16. The size of each of the convolution kernels K1 to K64 is 3×3×16. Therefore, the size of each of the convolution kernels K1 to K64 is less than the computation amount of convolution computation.

If the size of the convolution kernel is not less than the computation amount of convolution computation, the processor 150 may perform batch computation according to the above embodiments (as shown in FIG. 9 to FIG. 13). If the processor 150 judges that the size of the convolution kernel is less than the computation amount of convolution computation, the input data may be repeatedly provided for the convolution kernels to perform convolution computation. The number of duplications of the input data is the same as a multiple. The multiple is the quotient obtained by taking the computation amount as the dividend and the size of each convolution kernel as the divisor.

Taking FIG. 14 as an example, the computation amount is 4 times the size of each of the convolution kernels K1 to K64. That is, the multiple is 4. At this time, the processor 150 may respectively compute four identical input data Pixel with the convolution kernels K1 to K4 at the same time and output the computation result or respectively compute four identical input data Pixel with the convolution kernels K61 to K64 at the same time and output the computation result, and the rest may be analogized.

Taking FIG. 15 as an example, the computation amount is twice the size of each of the convolution kernels K1 to K64. That is, the multiple is 2. At this time, the processor 150 may respectively compute four identical input data Pixel with the convolution kernels K1 to K2 at the same time and output the computation result or respectively compute four identical input data Pixel with the convolution kernels K63 to K62 at the same time and output the computation result, and the rest may be analogized.

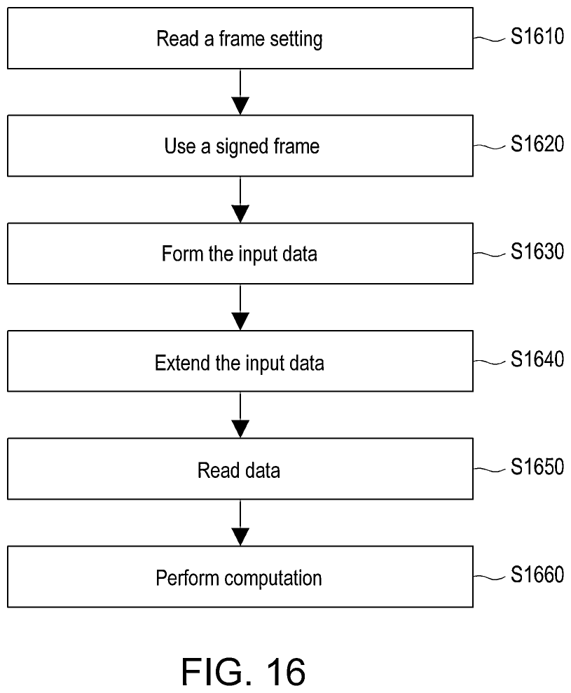

FIG. 16 is a flowchart of overall data processing according to an embodiment of the disclosure. Please refer to FIG. 16. In an embodiment, the processor 150 may read a frame setting (Step S1610). For example, the setting is (w, h, c, p), where w is the width of the input data, h is the height of the input data, c is the channel of the input data, and p is the padding mode. According to the padding mode, the processor 150 may use a signed frame (Step S1620). For example, the processor 150 judges that a specific padding mode is set. The processor 150 may form the non-extended input data (Step S1630), and extend the input data (Step S1640). For example, the data in FIG. 7A is extended to the data in FIG. 8B. The processor 150 may use the location information to read partial data stored in the memory 110 or the memory banks Bk₀ to Bkₘ₋₁ in FIG. 8 (Step S1650), and may push the read data to a specific processing element 151 to perform multiply accumulate or convolution computation (Step S1660). It should be noted that for the detailed operations of Steps S1610 to S1660, reference may be respectively made to the descriptions of FIG. 2 to FIG. 15, which will not be repeated.

In summary, in the data processing method and circuit based on convolution computation according to the embodiments of the disclosure, the shared memory structure is provided, convolution computation of data in batches or duplicated data is provided, the allocation mechanism for storing data into multiple memories is provided, and the signed padding mechanism is provided. Therefore, a flexible and efficient convolution computation mechanism and structure can be provided.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A data processing method based on convolution computation, comprising:
extending input data according to a padding mode to generate extended input data, wherein the input data is used for convolution computation;
providing coordinates of a two-dimensional coordinate system to a plurality of elements in the extended input data; and
reading the elements in the extended input data according to location information, wherein the location information comprises a size of non-extended input data and coordinates of the elements in the extended input data, and the step of reading the elements in the extended input data comprises:
in response to a coordinate of one of the elements in the location information being located outside the non-extended input data in the two-dimensional coordinate system, converting the coordinate in the location information according to the padding mode, wherein the coordinate in the location information is mapped to a coordinate of the non-extended input data.

2. The data processing method based on convolution computation according to claim 1, wherein the step of providing the coordinates of the two-dimensional coordinate system to the elements in the extended input data comprises:
setting coordinates of the non-extended input data to be between 0 and w in a first dimension and between 0 and h in a second dimension, where w is a width of the non-extended input data and h is a height of the non-extended input data; and
setting coordinates in the extended input data not belonging to the non-extended input data to be less than zero or greater than w in the first dimension and less than zero or greater than h in the second dimension.

3. The data processing method based on convolution computation according to claim 2, wherein the step of reading the elements in the extended input data according to the location information comprises:
determining whether a coordinate of one of the elements corresponding to the location information is less than zero or greater than w in the first dimension; and
determining whether a coordinate of the element corresponding to the location information is less than zero or greater than h in the second dimension.

4. The data processing method based on convolution computation according to claim 2, wherein the padding mode is a reflect mirror mode, and the step of converting the coordinate in the location information according to the padding mode comprises:
determining that a coordinate of one of the elements corresponding to the location information is less than zero in the first dimension, and further converting a first coordinate of the element in the first dimension into an absolute value of the first coordinate;
determining that a coordinate of the element corresponding to the location information is greater than w in the first dimension, and further converting the first coordinate of the element into a difference between the first coordinate and twice w;
determining that a coordinate of the element corresponding to the location information is less than zero in the second dimension, and further converting a second coordinate of the element in the second dimension into an absolute value of the second coordinate; and
determining that a coordinate of the element corresponding to the location information is greater than h in the second dimension, and further converting the second coordinate of the element into a difference between the second coordinate and twice h.

5. The data processing method based on convolution computation according to claim 2, wherein the padding mode is a symmetric mirror mode, and the step of converting the coordinate in the location information according to the padding mode comprises:
determining that a coordinate of one of the elements corresponding to the location information is less than zero in the first dimension, and further converting a first coordinate of the element in the first dimension into an absolute value of the first coordinate plus one;
determining that a coordinate of the element corresponding to the location information is greater than w in the first dimension, and further converting the first coordinate of the element into a difference between the first coordinate plus one and twice w;
determining that a coordinate of the element corresponding to the location information is less than zero in the second dimension, and further converting a second coordinate of the element in the second dimension into an absolute value of the second coordinate plus one; and
determining that a coordinate of the element corresponding to the location information is greater than h in the second dimension, and further converting the second coordinate of the element into a difference between the second coordinate plus one and twice h.

6. The data processing method based on convolution computation according to claim 1, wherein the input data is stored in a plurality of memories, and the data processing method further comprises:
according to a size of a storage space of a single address of each of the memories, storing a plurality of first partial data in the input data into the memories, wherein coordinates of at least one of the first partial data at each address in two-dimensional coordinates of the input data of any channel are different, and the address stores elements of a plurality of channels with same coordinates in the input data.

7. The data processing method based on convolution computation according to claim 1, further comprising:
reading a first convolution kernel group among a plurality of convolution kernels according to a size of a sum register, wherein a number of the convolution kernels in the first convolution kernel group is the same as the size of the sum register; and
temporarily storing a first convolution computation result of the input data and the first convolution kernel group into the sum register through first input first output (FIFO).

8. The data processing method based on convolution computation according to claim 7, further comprising:
judging that a size of one of the convolution kernels is less than a computation amount of convolution computation; and
repeatedly providing the input data for the convolution kernels to perform convolution computation.

9. A data processing circuit based on convolution computation, comprising:
at least one memory, used to store a code; and
a processor, coupled to the at least one memory and configured to load and execute the code to:
extend input data according to a padding mode to generate extended input data, wherein the input data is used for convolution computation;
provide coordinates of a two-dimensional coordinate system to a plurality of elements in the extended input data; and
read the elements in the extended input data according to location information, wherein the location information comprises a size of non-extended input data and coordinates of the elements in the extended input data, and the step of reading the elements in the extended input data comprises:
in response to a coordinate of one of the elements in the location information being located outside the non-extended input data in the two-dimensional coordinate system, converting the coordinate in the location information according to the padding mode, wherein the coordinate in the location information is mapped to a coordinate of the non-extended input data.

10. The data processing circuit based on convolution computation according to claim 9, wherein the processor is further configured to:
set coordinates of the non-extended input data to be between 0 and w in a first dimension and between 0 and h in a second dimension, where w is a width of the non-extended input data and h is a height of the non-extended input data; and
set coordinates in the extended input data not belonging to the non-extended input data to be less than zero or greater than w in the first dimension and less than zero or greater than h in the second dimension.

11. The data processing circuit based on convolution computation according to claim 10, wherein the processor is further configured to:
determine whether a coordinate of one of the elements corresponding to the location information is less than zero or greater than w in the first dimension; and
determine whether a coordinate of the element corresponding to the location information is less than zero or greater than h in the second dimension.

12. The data processing circuit based on convolution computation according to claim 10, wherein the padding mode is a reflect mirror mode, and the processor is further configured to:
determine that a coordinate of one of the elements corresponding to the location information is less than zero in the first dimension, and further convert a first coordinate of the element in the first dimension into an absolute value of the first coordinate;
determine that a coordinate of the element corresponding to the location information is greater than w in the first dimension, and further convert the first coordinate of the element into a difference between the first coordinate and twice w;
determine that a coordinate of the element corresponding to the location information is less than zero in the second dimension, and further convert a second coordinate of the element in the second dimension into an absolute value of the second coordinate; and
determine that a coordinate of the element corresponding to the location information is greater than h in the second dimension, and further convert the second coordinate of the element into a difference between the second coordinate and twice h.

13. The data processing circuit based on convolution computation according to claim 10, wherein the padding mode is a symmetric mirror mode, and the processor is further configured to:
determine that a coordinate of one of the elements corresponding to the location information is less than zero in the first dimension, and further convert a first coordinate of the element in the first dimension into an absolute value of the first coordinate plus one;
determine that a coordinate of the element corresponding to the location information is greater than w in the first dimension, and further convert the first coordinate of the element into a difference between the first coordinate plus one and twice w;
determine that a coordinate of the element corresponding to the location information is less than zero in the second dimension, and further convert a second coordinate of the element in the second dimension into an absolute value of the second coordinate plus one; and
determine that a coordinate of the element corresponding to the location information is greater than h in the second dimension, and further convert the second coordinate of the element into a difference between the second coordinate plus one and twice h.

14. The data processing circuit based on convolution computation according to claim 9, wherein the at least one memory comprises a plurality of memories, the input data is stored in the memories, and the processor is further configured to:
according to a size of a storage space of a single address of each of the memories, store a plurality of first partial data in the input data into the memories, wherein coordinates of at least one of the first partial data at each address in two-dimensional coordinates of the input data of any channel are different, and the address stores elements of a plurality of channels with same coordinates in the input data.

15. The data processing circuit based on convolution computation according to claim 9, wherein the processor is further configured to:
read a first convolution kernel group among a plurality of convolution kernels according to a size of a sum register, wherein a number of the convolution kernels in the first convolution kernel group is the same as the size of the sum register; and
temporarily store a first convolution computation result of the input data and the first convolution kernel group into the sum register through first input first output.

16. The data processing circuit according to claim 15, wherein the processor is further configured to:
judge that a size of one of the convolution kernels is less than a computation amount of convolution computation; and
repeatedly provide the input data for the convolution kernels to perform convolution computation.
